(19) United States
(12) Patent Application Publication
(10) Pub. No.: US 2015/0220247 A1
(43) Pub. Date: Aug. 6, 2015

(54) ELECTRONIC DEVICE AND METHOD FOR PROVIDING INFORMATION THEREOF

(71) Applicant: Samsung Electronics Co., Ltd., Gyeonggi-do (KR)

(72) Inventors: A.S.M. Hossain Bari, Bogra (BD); Shohel Ahmed, Gazipur (BD); Shegufta Bakht Ahsan, Dhaka (BD); Md. Tawhidul Islam Chowdhury, Dhaka (BD); Sadre Ala Parvez, Dhaka (BD); Syeda Persia Aziz, Dhaka (BD)

(21) Appl. No.: 14/614,244

(22) Filed: Feb. 4, 2015

(30) Foreign Application Priority Data
Feb. 4, 2014 (KR) 10-2014-0012572

(51) Int. Cl. G06F 3/0481; H04M 1/725; G06F 3/0484

(52) U.S. Cl. CPC G06F 3/04817; G06F 3/04842; H04M 1/72522

(57) ABSTRACT

A method for operating an electronic device includes distinguishing a first application that is running in the electronic device from a second application that is not running, and adding a distinctive appearance on the a first app-icon representing the running application, displaying the first app-icon distinctively from the second app-icon on a screen of the electronic device. An electronic device includes a control unit configured to distinguish a first application that is running in the electronic device from a second application that is not running, and add a distinctive appearance on the a first app-icon representing the running application, and a display configured to display the first app-icon distinctively from the second app-icon on a screen of the electronic device.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0012572, filed on Feb. 4, 2014, which is hereby incorporated by reference for all purposes as if fully set forth herein.

### TECHNICAL FIELD

Various embodiments of the present disclosure relate to a method for providing various pieces of information on applications by using application icons and an electronic device using the same.

### BACKGROUND

Thanks to the recent development of a communication technology, applications of various functions are downloaded to be used in electronic devices, for example, PCs, mobile terminals such as smart phones, and smart TVs. When the applications are downloaded in the electronic devices, application icons may be displayed on a display to allow a user to access the application with convenience. For example, a plurality of icons of applications that are installed in the electronic device may be displayed in the home screen image. The user may select the application icon to thereby execute the corresponding application.

If the application is executed by selecting the application icon, the execution screen image may be displayed through a display of the electronic device. The user may end the execution of the application by closing the execution screen image, or may maintain the execution of the application in the background by minimizing the execution screen image. Therefore, even though the home screen image is displayed on the display, some applications may be running in the background.

### SUMMARY

According to prior art, in order to check the application that is running, the user should execute a separate menu for displaying operation management items to thereby obtain the corresponding information. In addition, manipulation for the application running should be carried out through the menu for displaying the operation management items. Furthermore, in order to obtain information on the application, the user should execute the corresponding application and should access the corresponding item.

To address the above-discussed deficiencies, it is a primary object to provide an electronic device and a method for providing information thereof.

In accordance with an aspect of the present disclosure, a method for operating an electronic device includes distinguishing a first application that is running in the electronic device from a second application that is not running, and adding a distinctive appearance on the a first app-icon representing the running application, displaying the first app-icon distinctively from the second app-icon on a screen of the electronic device.

In accordance with another aspect of the present disclosure, an electronic device includes a control unit configured to distinguish a first application that is running in the electronic device from a second application that is not running, and add a distinctive appearance on the a first app-icon representing the running application, and a display configured to display the first app-ic on distinctively from the second app-icon on a screen of the electronic device.

In some embodiments, the first app-icon has a distinctive feature comprising at least one of a color, a shade, a size and a design.

In some embodiments, all of first app-icons are displayed in the same distinctive feature and all of second app-icons are displayed in a different feature.

In some embodiments, the control unit is further configured to in response to detecting a change in an execution state of a running application, remove the distinctive appearance from the first app-icon.

In some embodiments, the control unit is further configured to receive a selection of one of app-icons from an input unit, and cause the screen to display a function list of the application corresponding to the selected app-icon.

In some embodiments, if the selected app-icon is one of the first app-icon, the function list includes operation management items related to the app-icon, and if the selected app-icon is one of the second app-icon, the function list includes at least one of operation management items related to the app-icon, operation management items related to the application, a bookmark related to the application, and preference items related to the application.

In some embodiments, the control unit is further configured to identify properties of the application corresponding to the selected app-icon.

In some embodiments, the function list includes the properties of the application corresponding to the selected app-icon.

In some embodiments, the properties includes at least one of operation management items related to the app-icon, operation management items related to the application, a bookmark related to the application, and preference items related to the application.

In accordance with another aspect of the present disclosure, a computer-readable recording medium storing a program for performing, when executed by a processor, the operations of distinguishing a first application that is running in the electronic device from a second application that is not running; and adding a distinctive appearance on the a first app-icon representing the running application, displaying the first app-icon distinctively from the second app-icon on a screen of the electronic device.

In a method for providing information of an electronic device according to an embodiment of the present disclosure, information on the applications that are running in the background can be obtained without additional manipulation by the user.

In a method for providing information of an electronic device according to an embodiment of the present disclosure, the user can obtain information related to an application by using app-icons in the home screen image.

In addition, in a method for providing information of an electronic device according to an embodiment of the present disclosure, the user can obtain various pieces of information related to applications by making inputs of various properties.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to an embodiment of the present disclosure;

FIG. 2 is a block diagram of an electronic device according to an embodiment of the present disclosure;

FIGS. 3a to 3c are diagrams of screen images illustrating a method for providing information of an electronic device according to an embodiment of the present disclosure;

FIGS. 4a to 4c are diagrams of screen images illustrating a method for providing information of an electronic device according to an embodiment of the present disclosure;

FIG. 5a is a diagram illustrating an input device according to an embodiment of the present disclosure;

FIGS. 5b and 5c are diagrams of screen images illustrating various input methods using the input device of FIG. 5 in order to provide information.

FIG. 6 is a flowchart illustrating a method for providing application-execution-information in an electronic device according to an embodiment of the present disclosure; and

FIG. 7 is a flowchart illustrating a method for providing information related to an application in an electronic device according to an embodiment of the present disclosure.

### DETAILED DESCRIPTION

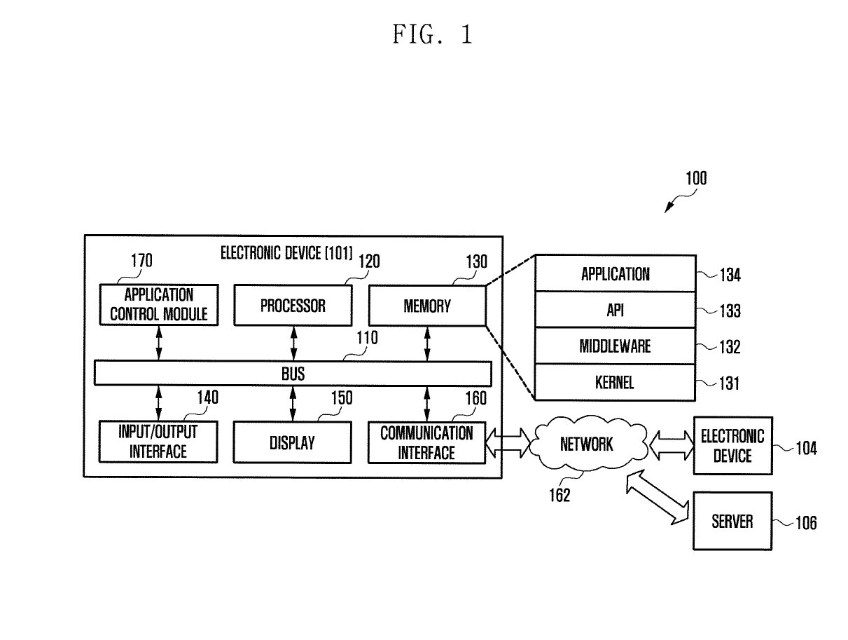

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, the present disclosure will be described with reference to the accompanying drawings. The present disclosure may have various embodiments, and modifications and changes may be made therein. Therefore, the present disclosure will be described in detail with reference to particular embodiments shown in the accompanying drawings. However, it should be understood that there is no intent to limit the present disclosure to the particular forms, and the present disclosure should be construed to cover all modifications, equivalents, and/or alternatives falling within the spirit and scope of the present disclosure. In describing the drawings, similar elements are designated by similar reference numerals.

As used in the present disclosure, the expression “include” or “may include” refers to the existence of a corresponding function, operation, or constituent element, and does not limit one or more additional functions, operations, or constituent elements. Further, as used in the present disclosure, the term such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

As used in the present disclosure, the expression “or” includes any or all combinations of words enumerated together. For example, the expression “A or B” may include A, may include B, or may include both A and B.

While expressions including ordinal numbers, such as “first” and “second”, as used in the present disclosure may modify various constituent elements, such constituent elements are not limited by the above expressions. For example, the above expressions do not limit the sequence and/or importance of the corresponding constituent elements. The above expressions may be used merely for the purpose of distinguishing a constituent element from other constituent elements. For example, a first user device and a second user device indicate different user devices although both are user devices. For example, a first constituent element may be termed a second constituent element, and likewise a second constituent element may also be termed a first constituent element without departing from the scope of the present disclosure.

When a component is referred to as being “connected” or “accessed” to any other component, it should be understood that the component may be directly connected or accessed to the other component, but another new component may also be interposed between them. Contrarily, when a component is referred to as being “directly connected” or “directly accessed” to any other component, it should be understood that there is no new component between the component and the other component.

The terms as used in various embodiments of the present disclosure are merely for the purpose of describing particular embodiments and are not intended to limit the present disclosure. Singular forms are intended to include plural forms unless the context clearly indicates otherwise.

Unless defined otherwise, all terms used herein, including technical teems and scientific terms, have the same meaning as commonly understood by a person of ordinary skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to the present disclosure may be a device including a communication function. For example, the electronic device can include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic accessory, electronic tattoos, or a smartwatch).

According to some embodiments, the electronic device can be a smart home appliance with a communication function. The smart home appliance as the electronic device, for example, can include at least one of a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

According to some embodiments, the electronic devices can include at least one of various medical devices (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) in a shop.

According to some embodiments, the electronic device can include at least one of a part of furniture or a building/structure, an electronic board, an electronic signature receiving device, a projector, and various kinds of measuring instruments (e.g., a water meter, an electric meter, a gas meter, and a radio wave meter). The electronic device according to the present disclosure can be a combination of one or more of the aforementioned various devices. Further, the electronic device according to the present disclosure can be a flexible device. Further, it will be apparent to those skilled in the art that the electronic device according to the present disclosure is not limited to the aforementioned devices.

Hereinafter, an electronic device according to various embodiments of the present disclosure will be discussed with reference to the accompanying drawings. The term “a user” as used in various embodiments can refer to any person who uses an electronic device or any other device (e.g., an artificial intelligence electronic device) using an electronic device.

FIG. 1 illustrates a network environment 100 including an electronic device 101 according to various embodiments of the present disclosure. Referring to FIG. 1, the electronic device 101 can include a bus 110, a processor 120, a memory 130, an input/output interface 140, a display 150, a communication interface 160, and an application control module 170.

The bus 110 can be a circuit interconnecting the aforementioned components and transmitting communication (e.g., a control message) between the aforementioned components.

The processor 120, for example, can receive instructions from the aforementioned components (e.g., the memory 130, the input/output interface 140, the display 150, the communication interface 160, and the application control module 170) other than the processor 120 through the bus 110, decode the received instructions, and perform operations or data processing according to the decoded instructions.

The memory 130 can store instructions or data received from or generated by the processor 120 or other components (e.g., the input/output interface 140, the display 150, the communication interface 160, and the application control module 170). The memory 130 can include programming modules, for example, a kernel 131, middleware 132, an application programming interface (API) 133, and applications 134. Each of the programming modules as described above can be formed by software, firmware, hardware, or a combination of two or more thereof.

The kernel 131 can control or manage system resources (e.g., the bus 110, the processor 120, and the memory 130) used to execute operations or functions implemented in the remaining other programming modules, for example, the middleware 132, the API 133, and the applications 134. Further, the kernel 131 can provide an interface that allows the middleware 132, the API 133, or the applications 134 to access and control or manage individual components of the electronic device 101.

The middleware 132 can serve to mediate between the API 133 or the applications 134 and the kernel 131, that is, allow the API 133 or the application 134 to communicate and exchange data with the kernel 131. Further, the middleware 132 can perform control (e.g., scheduling or load balancing) for task requests received from the applications 134 by using, for example, a method of assigning a priority for use of the system resource (e.g., the bus 110, the processor 120, or the memory 130) of the electronic device 101 to at least one of the applications 134.

The API 133 is an interface for allowing the applications 134 to control functions provided by the kernel 131 and the middleware 132, and can include at least one interface or function (e.g., instruction) for, for example, file control, window control, image processing, or text control.

According to various embodiments, the applications 134 can include an SMS/MMS application, an e-mail application, a calendar application, an alarm application, a health care application (e.g., an application for measuring the amount of exercise or blood glucose), and an environmental information application (e.g., an application for providing atmospheric pressure information, humidity information, temperature information, and the like). Additionally or alternatively, the applications 134 can include an application associated with information exchange between the electronic device 101 and an external electronic device (e.g., the electronic device 104). The application associated with information exchange, for example, can include a notification relay application for transferring specific information to the external electronic device or a device management application for managing the external electronic device.

For example, the notification relay application can include a function of transferring notification information, generated in another application of the electronic device 101 (e.g., the SMS/MMS application, the e-mail application, the health care application, or the environmental information application), to an external electronic device (e.g., the electronic device 104). Additionally or alternatively, the notification relay application, for example, can receive notification information from an external electronic device (e.g., the electronic device 104) and provide the received notification information to a user. The device management application, for example, can manage (e.g., install, remove, or update) a function for at least a part of an external electronic device (e.g., the electronic device 104) communicating with the electronic device 101 (e.g., a function of turning on/off an external electronic device itself (or some components thereof) or adjusting the brightness (or resolution) of a display), an application running on the external electronic device, or a service provided in the external electronic device (e.g., a calling or messaging service).

According to various embodiments, the applications 134 can include an application specified according to the attribute (e.g., type) of an external electronic device (e.g., the electronic device 104). For example, when the external electronic device is an MP3 player, the applications 134 can include an application associated with music playback. Similarly, when the external electronic device is a mobile medical device, the applications 134 can include an application associated with health care. According to an embodiment, the applications 134 can include at least one of an application assigned to the electronic device 101 and an application received from an external electronic device (e.g., the server 106 or the electronic device 104).

The input/output interface 140, for example, can transfer instructions or data, input from a user through an input/output device (e.g., a sensor, a keyboard, or a touch screen), to the processor 120, the memory 130, the communication interface 160, or the application control module 170 through the bus 110. For example, the input/output interface 140 can provide the processor 120 with data corresponding to a user's touch input through a touch screen. Further, the input/output interface 140 can, for example, receive instructions or data from the processor 120, the memory 130, the communication interface 160, or the application control module 170 through the bus 110 and output the received instructions or data through the input/output device (e.g., a speaker or a display). For example, the input/output interface 140 can output voice data processed by the processor 120 to a user through a speaker.

The display 150 can display various pieces of information (e.g., multimedia data or text data) to a user.

The communication interface 160 can establish communication between the electronic device 101 and an external electronic device (e.g., the electronic device 104 or the server 106). For example, the communication interface 160 can be connected to the network 162 through wireless or wired communication and thereby communicate with the external device. The wireless communication, for example, can include at least one of wireless fidelity (WiFi), Bluetooth (BT), near field communication (NFC), a global positioning system (GPS), and cellular communication (e.g., LTE, LTE-A, CDMA, CDMA, UMTS, WiBro, or GSM). The wired communication, for example, can include at least one of a universal serial bus (USB), a high definition multimedia interface (HDMI), recommended standard 232 (RS-232), and a plain old telephone service (POTS).

According to an embodiment, the network 162 can be a telecommunications network. The telecommunications network can include at least one of a computer network, the Internet, the Internet of things, and a telephone network. According to an embodiment, a protocol (e.g., a transport layer protocol, a data link layer protocol, or a physical layer protocol) for communication between the electronic device 101 and an external device can be supported by at least one of the applications 134, the application programming interface 133, the middleware 132, the kernel 131, and the communication interface 160.

The application control module 170 can process at least some pieces of information acquired from other components (e.g., the processor 120, the memory 130, the input/output interface 140, and the communication interface 160) and provide the processed information to a user in various ways. For example, the application control module 170 can recognize information on connection components provided in the electronic device 101, store the information on connection components in the memory 130, and execute the applications 130, based on the stored information on connection components.

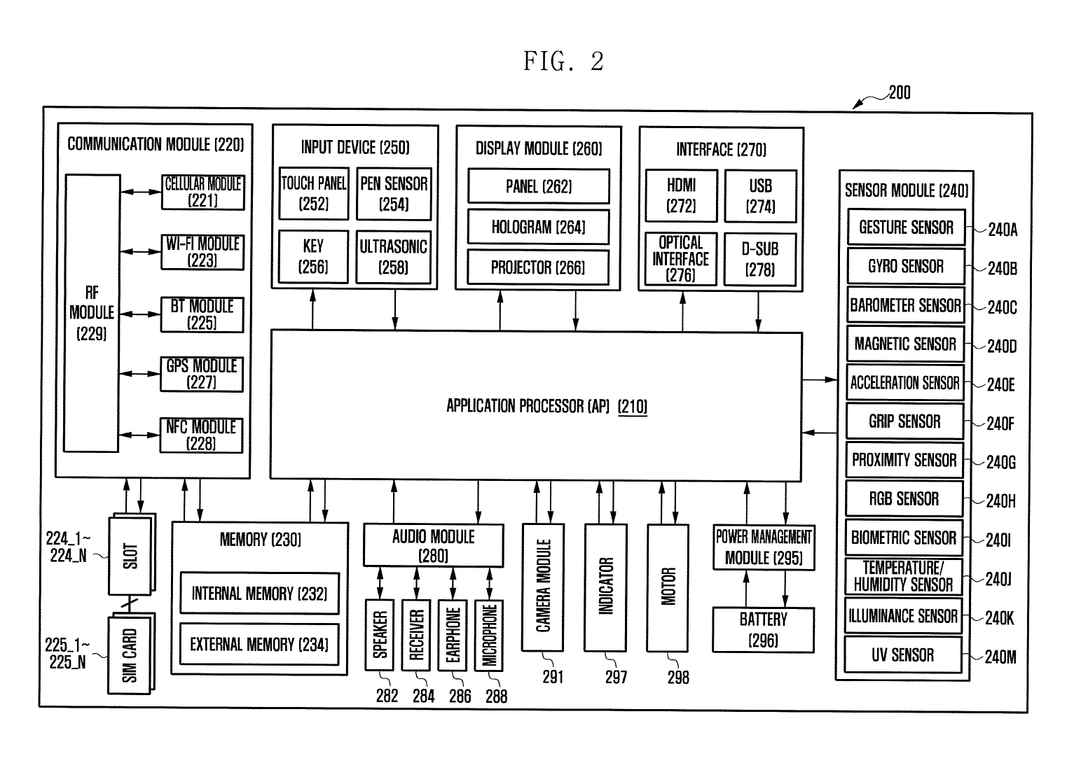

FIG. 2 illustrates a block diagram of an electronic device according to various embodiments. The electronic device 200, for example, can constitute all or a part of the electronic device 101 shown in FIG. 1.

Referring to FIG. 2, the electronic device 200 can include at least one application processor (AP) 210, a communication module 220, at least one subscriber identity module (SIM) card slots 224_1˜224_N, a memory 230, a sensor module 240, an input module 250, a display 260, an interface 270, an audio module 280, a camera module 291, a power management module 295, a battery 296, an indicator 297, and a motor 298.

The AP 210 can drive an operating system or an application program to control a plurality of hardware or software components connected to the AP 210, and can perform processing and operations of various data including multimedia data. The AP 210, for example, can be implemented as a system on chip (SoC). According to an embodiment, the AP 210 can further include a graphic processing unit (GPU) (not shown).

The communication module 220 (e.g., the communication interface 160) can perform data transmission/reception in communication with other electronic devices (e.g., the electronic device 104 and the server 106) connected to the electronic device 200 (e.g., the electronic device 101) through a network. According to an embodiment, the communication module 220 can include a cellular module 221, a WiFi module 223, a BT module 225, a GPS module 227, an NFC module 228, and a radio frequency (RF) module 229.

The cellular module 221 can provide a voice call, a video call, an SMS service, an Internet service, and the like through a communication network (e.g., LTE, LTE-A, CDMA, WCDMA, UMTS, WiBro, or GSM). Also, the cellular module 221 can identify and authenticate an electronic device in a communication network by using, for example, a subscriber identification module (e.g., the SIM card). According to an embodiment, the cellular module 221 can perform at least some of the functions that can be provided by the AP 210. For example, the cellular module 221 can perform at least a multimedia control function.

According to an embodiment, the cellular module 221 can include a communication processor (CP). Further, the cellular module 221, for example, can be implemented as a SoC. Although the cellular module 221 (e.g., a CP), the memory 230, the power management module 295, and the like are shown as separate elements from the AP 210 in FIG. 2, the AP 210 can be implemented to include at least some (e.g., the cellular module 221) of the aforementioned elements according to an embodiment.

According to an embodiment, the AP 210 or the cellular module 221 (e.g., a CP) can load a command or data received from at least one of a non-volatile memory and other elements connected thereto into a volatile memory and process the loaded command or data. Further, the AP 210 or the cellular module 221 can store data received from or generated by at least one of other elements in a non-volatile memory.

Each of the WiFi module 223, the BT module 225, the GPS module 227, and the NFC module 228, for example, can include a processor for processing data transmitted or received through the corresponding module. Although the cellular module 221, the WiFi module 223, the BT module 225, the GPS module 227, and the NFC module 228 are shown as separate blocks in FIG. 2, at least some (e.g., two or more) of the cellular module 221, the WiFi module 223, the BT module 225, the GPS module 227, and the NFC module 228 can be included in one integrated chip (IC) or one IC package according to an embodiment. For example, at least some of processors corresponding to the cellular module 221, the WiFi module 223, the BT module 225, the GPS module 227, and the NFC module 228 respectively (e.g., a CP corresponding to the cellular module 221 and a WiFi processor corresponding to the WiFi module 223) can be implemented as one SoC.

The RF module 229 can perform data transmission/reception, for example, RF signal transmission/reception. Although not shown in the drawing, the RF module 229, for example, can include a transceiver, a power amp module (PAM), a frequency filter, a low noise amplifier (LNA), and the like. Also, the RF module 229 can further include a component for transmitting/receiving an electromagnetic wave over the air in wireless communication, such as a conductor or a conducting wire. Although FIG. 2 shows that the cellular module 221, the WiFi module 223, the BT module 225, the GPS module 227, and the NFC module 228 share one RF module 229, at least one of the cellular module 221, the WiFi module 223, the BT module 225, the GPS module 227, and the NFC module 228 can perform RF signal transmission/reception through a separate RF module according to an embodiment.

The at least one SIM card 225_1 to 225_N can be a card including a subscriber identification module, and can be inserted into at least one slot 224_1 to 224_N formed in a certain position of the electronic device. The at least one SIM card 225_1 to 225_N can include unique identification information (e.g., integrated circuit card identifier (ICCID)) or subscriber information (e.g., international mobile subscriber identity (IMSI)).

The memory 230 (e.g., the memory 130) can include an internal memory 232 or an external memory 234. The internal memory 232, for example, can include at least one of a volatile memory (e.g., a dynamic RAM (DRAM), a static RAM (SRAM), or a synchronous dynamic RAM (SDRAM)) and a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or an NOR flash memory).

According to an embodiment, the internal memory 232 can be a solid state drive (SSD). The external memory 234 can further include a flash drive, for example, a compact flash (CF), a secure digital (SD), a micro secure digital (Micro-SD), a mini secure digital (Mini-SD), an extreme digital (xD), or a memory stick. The external memory 234 can be functionally connected to the electronic device 200 through various interfaces. According to an embodiment, the electronic device 200 can further include a storage device (or storage medium) such as a hard drive.

The sensor module 240 can measure a physical quantity or detect an operation state of the electronic device 200 and convert the measured or detected information into an electronic signal. The sensor module 240, for example, can include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, a light sensor 240K, and a ultraviolet (UV) sensor 240M. Additionally or alternatively, the sensor module 240, for example, can include an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scanner (not shown), and/or a fingerprint sensor (not shown). The sensor module 240 can further include a control circuit for controlling one or more sensors included therein.

The input module 250 can include a touch panel 252, a (digital) pen sensor 254, a key 256, or an ultrasonic input unit 258. The touch panel 252 that recognizes a touch input, for example, can include at least one of a capacitive touch panel, a resistive touch panel, an infrared touch panel, and an acoustic wave touch panel. Also, the touch panel 252 can further include a control circuit. When the touch panel is a capacitive touch panel, it can recognize a physical contact or proximity. The touch panel 252 can also further include a tactile layer. In this case, the touch panel 252 can provide a tactile response to a user.

The (digital) pen sensor 254, for example, can be implemented using a means identical or similar to a means for receiving a touch input from a user or using a separate recognition sheet. The key 256, for example, can include a physical button, an optical key, or a keypad. The ultrasonic input unit 258 is a unit that can identify data by generating an ultrasonic signal through an input tool and detecting a sonic wave through a microphone (e.g., the microphone 688) in the electronic device 600, and is capable of wireless recognition. According to an embodiment, the electronic device 200 can also receive a user input from an external device (e.g., computer or server) connected thereto by using the communication module 220.

The display 260 (e.g., the display 150) can include a panel 262, a hologram unit 264, or a projector 266. The panel 262, for example, can be a liquid crystal display (LCD) or an active matrix-organic light emitting diode (AM-OLED). The panel 262, for example, can be implemented to be flexible, transparent, or wearable. The panel 262 can also be incorporated into one module together with the touch panel 252. The hologram unit 264 can show a stereoscopic image in the air by using light interference. The projector 266 can display an image by projecting light onto a screen. The screen, for example, can be located inside or outside of the electronic device 200. According to an embodiment, the display 260 can further include a control circuit for controlling the panel 262, the hologram unit 264, or the projector 266.

The interface 270, for example, can include a high-definition multimedia interface (HDMI) 272, a universal serial bus (USB) 274, an optical interface 276, or a D-subminiature (D-sub) 278. The interface 270, for example, can be included in the communication interface 160 shown in FIG. 1. Additionally or alternatively, the interface 290, for example, can include a mobile high-definition link (MHL) interface, a secure digital (SD) card/multimedia card (MMC) interface, or an infrared data association (IrDA) interface.

The audio module 280 can provide bidirectional conversion between a sound and an electronic signal. At least some elements of the audio module 280, for example, can be included in the input/output interface 140 shown in FIG. 1. The audio module 280, for example, can process sound information input or output through a speaker 282, a receiver 284, earphones 286, or the microphone 288.

The camera module 291 is a device that can take both still and moving images, and according to an embodiment, can include one or more image sensors (e.g., a front sensor or a rear sensor, not shown), a lens (not shown), an image signal processor (ISP) (not shown), or a flash (e.g., an LED or xenon lamp, not shown).

The power management module 295 can manage power of the electronic device 200. Although not shown, the power management module 295, for example, can include a power management integrated circuit (PMIC), a charger IC, or a battery or fuel gauge.

The PMIC, for example, can be mounted in an IC or a SoC semiconductor. Charging methods can be classified into wired charging and wireless charging. The charger IC can charge a battery, and can prevent an overvoltage or excess current from being induced or flowing from a charger. According to an embodiment, the charger IC can include a charger IC for at least one of the wired charging and the wireless charging. Examples of the wireless charging include magnetic resonance charging, magnetic induction charging, and electromagnetic charging, and an additional circuit such as a coil loop, a resonance circuit, and a rectifier can be added for the wireless charging.

The battery gauge, for example, can measure the residual capacity, charge in voltage, current, or temperature of the battery 296. The battery 296 can store or generate electricity, and can supply power to the electronic device 200 by using the stored or generated electricity. The battery 296, for example, can include a rechargeable battery or a solar battery.

The indicator 297 can display a specific status of the electronic device 200 or a part thereof (e.g., the AP 210), for example, a boot-up status, a message status, or a charging status. The motor 298 can convert an electrical signal into a mechanical vibration. Although not shown, the electronic device 200 can include a processing unit (e.g., GPU) for supporting a mobile TV. The processing unit for supporting a mobile TV can process media data pursuant to a certain standard, for example, digital multimedia broadcasting (DMB), digital video broadcasting (DVB), or media flow.

Each of the above described elements of the electronic device according to the present disclosure can be formed by one or more components, and the names of the corresponding elements can vary according to the type of the electronic device. The electronic device according to the present disclosure can include at least one of the above described elements, and can exclude some of the elements or further include other additional elements. Further, some of the elements of the electronic device according to the present disclosure can be coupled to form a single entity while performing the same functions as those of the corresponding elements before the coupling.

The term “module” as used in the present disclosure, for example, can mean a unit including one of hardware, software, and firmware or any combination of two or more of them. The “module”, for example, can be interchangeable with the term “unit”, “logic”, “logical block”, “component”, or “circuit”. The “module” can be the smallest unit of an integrated component or a part thereof. The “module” can be the smallest unit that performs one or more functions or a part thereof. The “module” can be mechanically or electronically implemented. For example, the “module” according to the present disclosure can include at least one of an application-specific integrated circuit (ASIC) chip, a field-programmable gate arrays (FPGA), and a programmable-logic device for performing certain operations, which are now known or will be developed in the future.

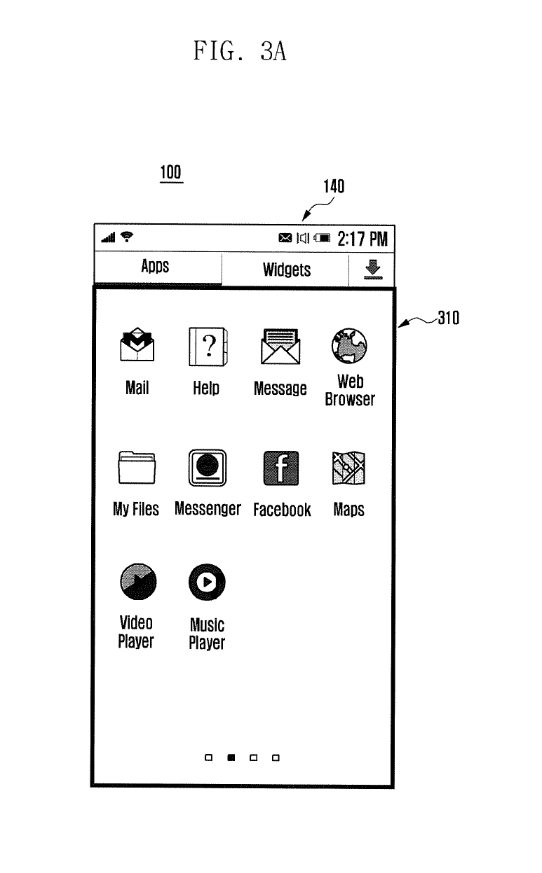

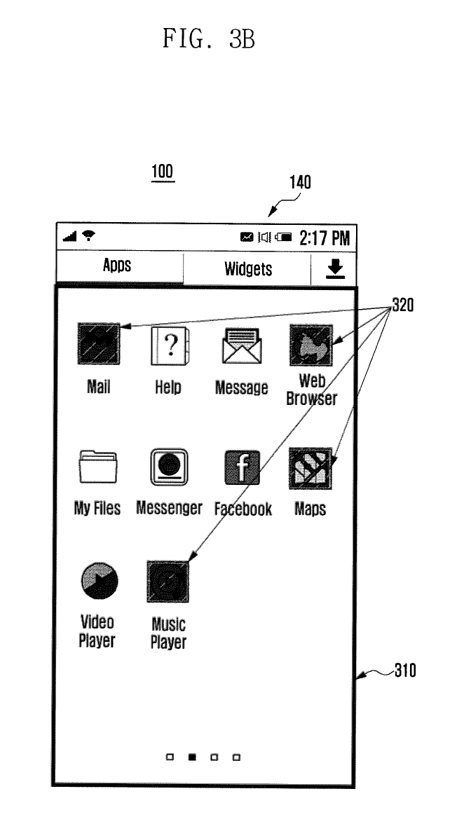

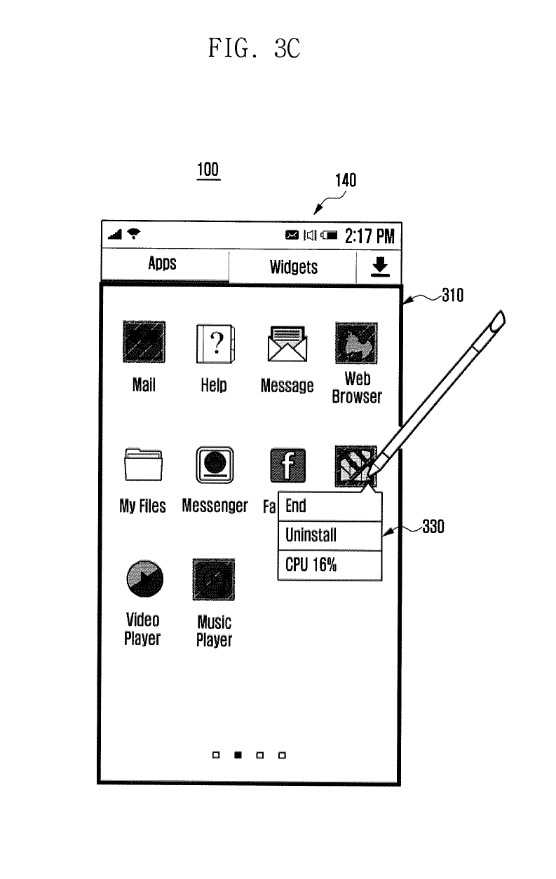

FIGS. 3A to 3C are diagrams of screen images illustrating a method for providing information of the electronic device 100 according to an embodiment of the present disclosure.

The electronic device 100 can store applications such as, for example, a phone call application and a message application as a default. In addition, the electronic device 100 can download applications for various functions by connecting other electronic devices through an electrical connection and/or a network connection, to thereby install and store the same. In order to allow the user to access the applications installed and stored as set forth above, the electronic device 100 can provide application icons (hereinafter, app-icons) through an app-icon display image, for example, a home screen image. The app-icons displayed on the app-icon display image can be configured as a default in the electronic device 100 or can be created by the user. For example, the app-icons can be basically provided in the electronic device 100 in the case of default applications. In the case of applications downloaded by the user, the app-icons can be created automatically at the time of downloading or can be created by user's selection, or the app-icons can be created by user's configuration after download.

The applications can be executed in the foreground of the display in the electronic device 100, or the applications can be executed in the background of the display by the manipulation of the user. For example, when the user presses a home key in the middle of execution of the application in the foreground, the electronic device 100 can output the home screen image with the application maintained to be executed in the background without terminating the executed application. In this way, a plurality of applications can be executed in the background.

Referring to FIGS. 1 to 3C, the electronic device 100 can include an input/output interface 140. For example, the input/output interface 140 can be comprised of a touch screen including a touch panel. The electronic device 100 can output an app-icon display image 310 including a plurality of app-icons through the input/output interface 140. Each of the app-icons can be symbolized by an image related to the corresponding application. FIG. 3A shows that no application is executed, and in this case, the app-icons displayed in the app-icon display image 310 can be in the same state, i.e., the first state. Meanwhile, FIG. 3B shows that at least one application is executed, and in this case, the app-icons 320 corresponding to the applications running can be in the second state different from the first state.

The state of the app-icon can include the state of at least one of color, shade, size and design of the app-icon. The app-icons in the same state mean that the app-icons are uniform in at least one of color, shade, size and design thereof. Therefore, the user can intuitively recognize the state of application corresponding to the app-icon in the uniform state, for example, whether or not the application is running in the background. In the present embodiment, the app-icons 320 corresponding to the active applications are displayed to be shaded.

The electronic device 100 can detect a change in the execution of the application. When the application is executed, the app-icon can switch from the first state to the second state, and when the active application is ended, the app-icon can return to the first state from the second state.

Referring to FIG. 3C, the electronic device 100 can receive an input for displaying related information on the app-icon displayed in the input/output interface 140. The related information-display-input can be received, for example, by a proximity input to the touch panel. When the related information-display-input is detected on a specific app-icon, the electronic device 100 can display the related information. The related information can vary with the applications. The related information can include operation management items related to the app-icons, for example, an item for uninstalling the app-icon, and operation management items related to the applications, for example, an item for ending the application, CPU usage information, or the like. As described in detail below, the related information can include a bookmark and preference items, which are related to the application. The related information can be output through a related information display window 330.

For example, if the electronic device 100 receives the related information-display-input about a specific app-icon, the electronic device 100 can provide different related information according to the execution of the application corresponding to the app-icon. More specifically, in the case of the application that is not running, the electronic device 100 can display the operation management items related to the app-icon as the related information. On the contrary, in the case of the application that is running, the electronic device 100 can display, as the related information, the operation management items related to the application as well as the operation management items related to the app-icon. FIG. 3c shows an embodiment in which the related information including the application “End” item, the app-icon “Uninstall” item, and CPU usage information is provided through the related information display window 330, when the electronic device 100 receives the related information-display-input about the application, i.e., “Maps”, which is running in the background.

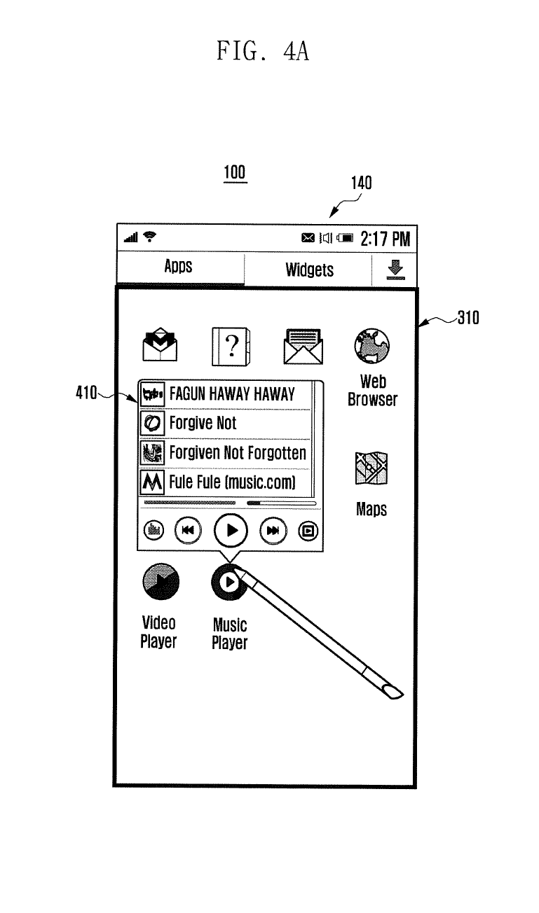

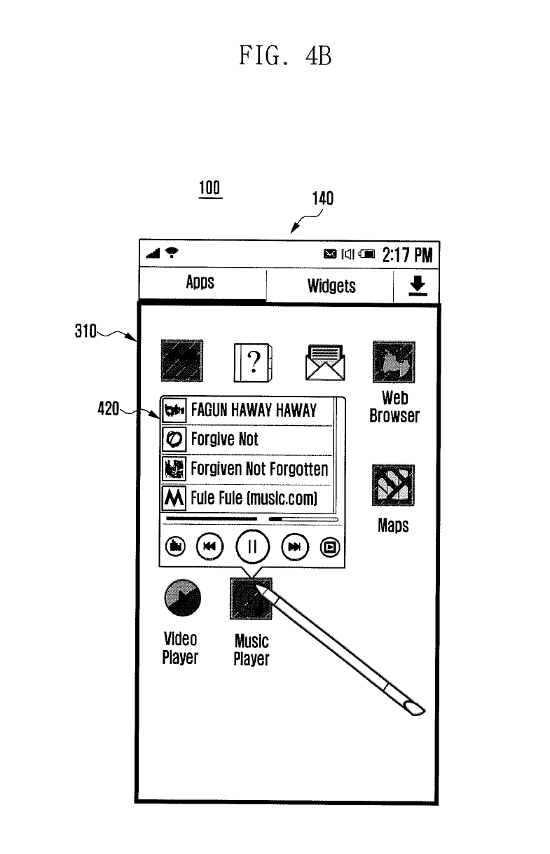

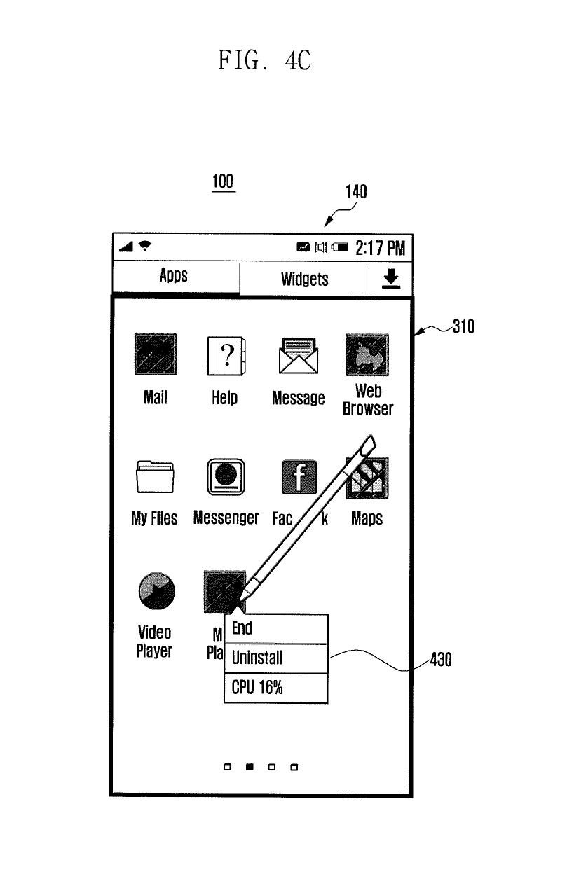

FIGS. 4A to 4C are diagrams of screen images illustrating various embodiments for providing the related information in the electronic device 100. FIGS. 4A to 4C show examples for providing the related information when the related information-display-input on the app-icon of an application “Music Player” is received.

FIG. 4A shows the case in which the related information-display-input is received through the music playing app-icon when the music playing application is not running. When the related information-display-input is detected on the music playing app-icon, the electronic device 100 can provide a recently played music list or a preference music list as the related information through the related information display window 410. Initial setup or user's setup can determine what is to be provided as the related information. In addition, the related information such as icons for playing, stopping and moving music and other indicators can be further provided in the related information display window 410.

The related information-display-input according to the present embodiment can have various properties. For example, if the related information-display-input is a proximity input, the properties of the related information-display-input can be determined to be different according to a proximity distance. Alternatively, the properties of the related information-display-input can be determined to be different according to the position where the related information-display-input is detected on the app-icons. Furthermore, the properties of the related information-display-input can be determined in various ways. The electronic device 100 according to the present embodiment can determine the provided related information according to the execution of the corresponding application. In addition, the electronic device 100 can identify the properties of the related information-display-input, and can determine the related information to be different on the basis of the identified properties.

FIGS. 4B and 4C show that even though the related information-display-input is received through the music playing app-icon while the music playing applications are running, different related information is provided according to the properties of the detected related information-display-input. The related information-display-input is received at the upper portion of the music playing app-icon in FIG. 4B, and the related information-display-input is received at the lower portion of the music playing app-icon in FIG. 4C. The electronic device 100 can identify the properties of the related information-display-input and can output the corresponding related information. For example, in the case of FIG. 4B in which the related information-display-input is received at the upper portion of the music playing app-icon, the current played music list can be provided as the related information through the related information display window 420. The related information display window 420 can further provide icons for playing, stopping and moving music, and other indicators as the related information. On the contrary, in the case of FIG. 4C in which the related information-display-input is received at the lower portion of the music playing app-icon, the operation management items related to the app-icon and the operation management items related to the application can be provided as the related information through the related information display window 430. Furthermore, various embodiments can be implemented.

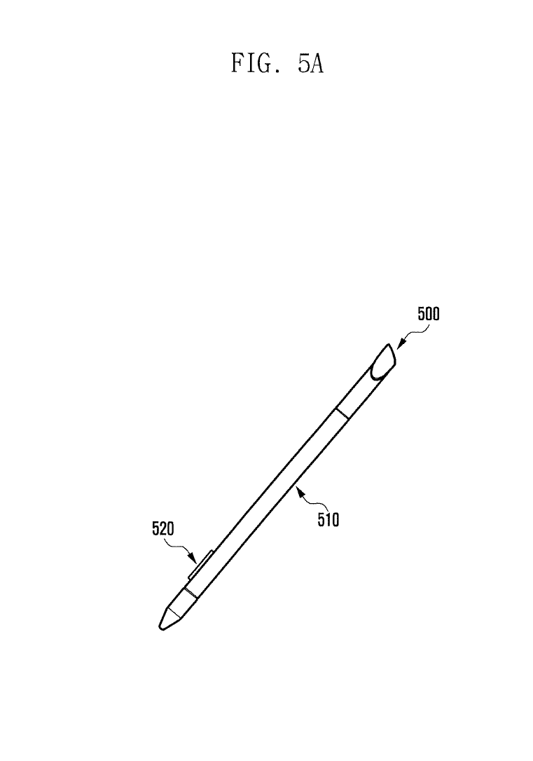

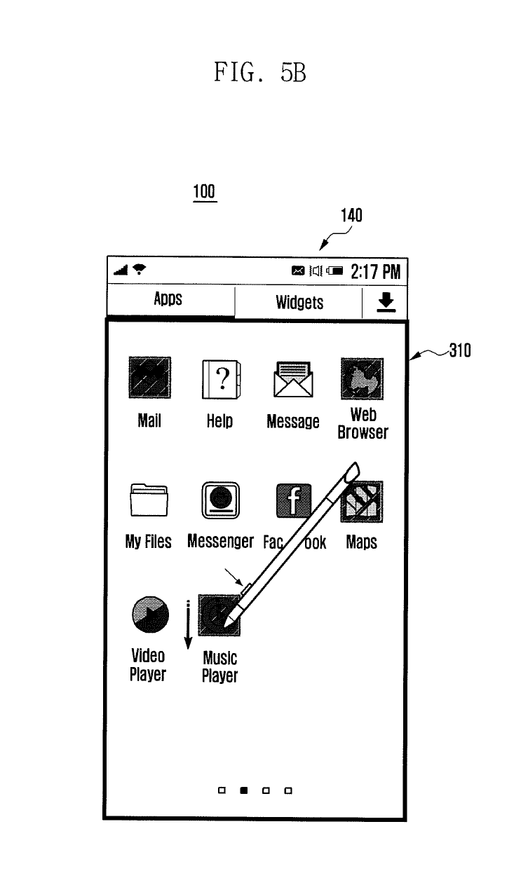

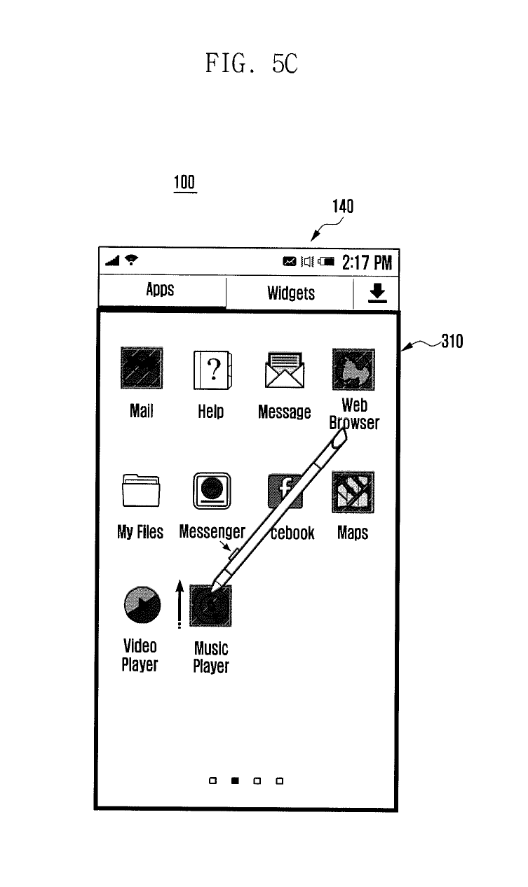

FIG. 5A is a diagram illustrating an input device 500 according to an embodiment of the present disclosure.

The input device 500 can include a body 510 and a button 520. The button 520 can be pressed by the user. The properties of the related information-display-input can be determined to be different according to whether or not the related information-display-input is provided while pressing the button 520.

Alternatively, if a touch input is provided on the app-icon by using the input device 500, the touch input can be determined to be an app-icon-selection-input or the related information-display-input according to the state of the button 520. For example, if the touch input is provided on the app-icon with the button 520 not pressed, the touch input can be determined to be the app-icon-selection-input for executing the application corresponding to the app-icon. Contrarily, if the touch input is provided on the app-icon with the button 520 pressed, the touch input can be determined to be the related information-display-input.

Referring to FIGS. 5B and 5C, if the touch input using the input device 500 is determined to be the related information-display-input, the electronic device 100 can provide different related information according to the properties of the related information-display-input. For example, the related information provided when detecting the touch input that moves from the upper portion to the lower portion of the app-icon as shown in FIG. 5B can be different from the related information provided when detecting the touch input that moves from the lower portion to the upper portion of the app-icon as shown in FIG. 5C. Furthermore, the related information-display-inputs can be provided to the electronic device 100 in various manners, and the electronic device 100 can provide the related information corresponding to the properties of the identified related information-display-input. The related information corresponding to the related information-display-input can be preset in the electronic device 100.

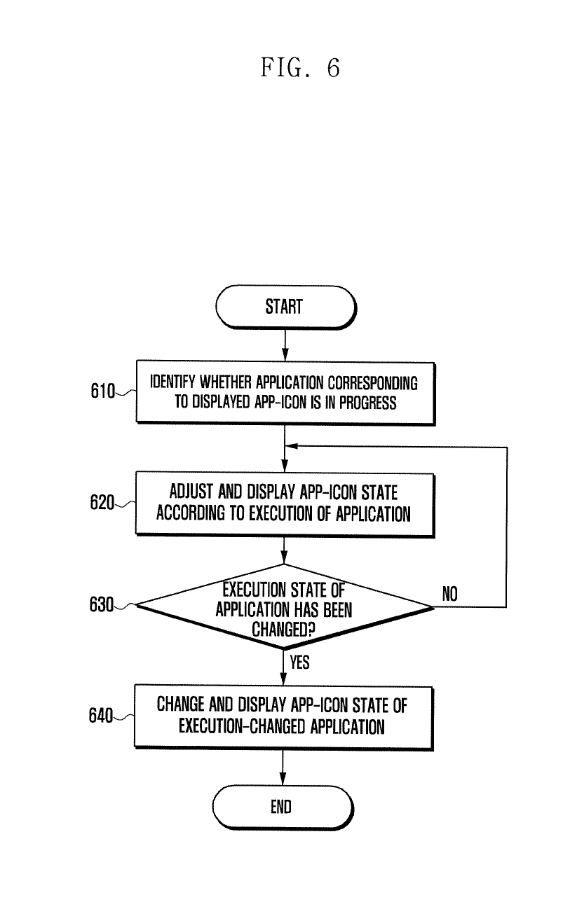

FIG. 6 is a flowchart illustrating a method for providing application-execution-information of the electronic device 100 according to an embodiment of the present disclosure.

The electronic device 100 can output the app-icon display image 310 through the input/output interface 140. The app-icon display image 310 can include at least one app-icon. The processor 120 of the electronic device 100 can identify whether or not the application corresponding to at least one app-icon displayed in the app-icon display image 310 is running in operation 610. The processor 120 can identify the application running in the background as well.

Afterwards, the processor 120 can adjust the state of the app-icon according to the execution of the corresponding application and can display the changed app-icon in operation 620. For example, the app-icon of the application that is not running can be displayed in the first state, and the app-icon of the application that is running can be displayed in the second state. The first state and the second state can be intuitively distinguished from each other in their features by the user. Furthermore, each of the app-icons in the first state and the app-icons in the second state can have a uniform feature that can be intuitively recognized by the user, respectively.

The processor 120 can detect whether or not the application has been changed in the execution in operation 630. If the execution state of the application has not been changed, the current displayed app-icon can remain. On the contrary, if the execution state of at least one application has been changed, the app-icon corresponding to the changed application can be changed in the state to be thereby displayed in operation 640. For example, if a specific application is executed, the app-icon corresponding to the application can switch from the first state to the second state, and if a specific application is terminated, the app-icon corresponding to the application can switch from the second state to the first state. Accordingly, the user can intuitively recognize whether or not the application is running by checking the state of the app-icon corresponding to the application, which is displayed through the input/output interface 140.

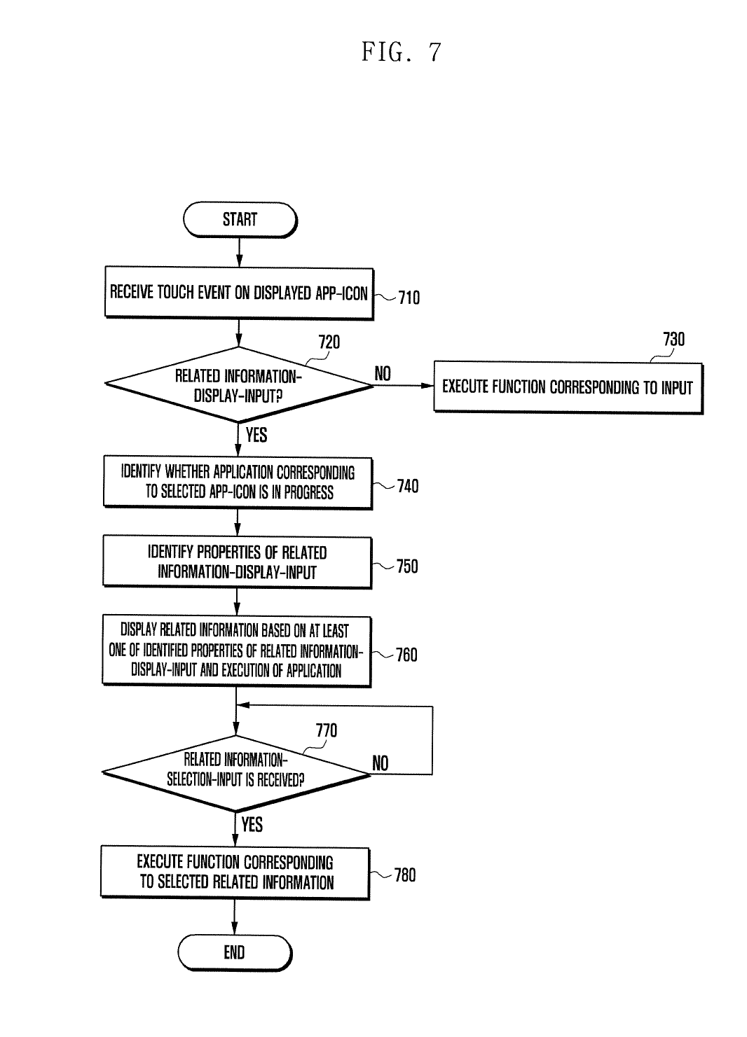

FIG. 7 is a flowchart illustrating a method for providing application-related information in the electronic device 100 according to an embodiment of the present disclosure.

The electronic device 100 can output the app-icon display image 310 through the input/output interface 140. The app-icon display image 310 can include at least one app-icon. The electronic device 100 can receive a touch event on a specific app-icon through the input/output interface 140 in operation 710.

The processor 120 can determine whether or not the touch event is the related information-display-input about the app-icon in operation 720. If the touch event is not the related information-display-input, the processor 120 can execute the function corresponding to the input in operation 730. For example, if the touch event is determined to be the app-icon-selection-input, the processor 120 can select the app-icon and execute the corresponding application.

On the contrary, if the touch event is the related information-display-input about the app-icon, the processor 120 can identify whether or not the application corresponding to the selected app-icon is running in the background in operation 740. Then, the processor can identify the properties of the received related information-display-input in operation 750. The processor can determine the related information on the basis of at least one of the properties of the identified related information-display-input and the execution of the application, and can display the determined related information through the input/output interface 140 in operation 760.

The user can recognize the related information of the selected app-icon and the application corresponding thereto by identifying the related information displayed through the input/output interface 140. The related information can include various items. The electronic device 100 can receive the related information-selection-input, by which at least one of the items included in the related information is selected, through the input/output interface 140 in operation 770. When the related information-selection-input is received, the processor 120 can execute the function corresponding to the selected item of the related information in operation 780.

According to various embodiments, at least some of the devices (for example, modules or functions thereof) or the method (for example, operations) according to the present disclosure can be implemented by a command stored in a computer-readable storage medium in a programming module form. When the command is executed by one or more processors, the one or more processors can perform a function corresponding to the command. The computer-readable storage medium can be, for example, the memory. At least some of the programming modules can be implemented (for example, executed) by, for example, the processor. At least some of the programming modules can include, for example, a module, a program, a routine, a set of instructions or a process for performing one or more functions.

The computer-readable recording medium can include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions can include high class language codes, which can be executed in a computer by using an interpreter, as well as machine codes made by a compiler. The aforementioned hardware device can be configured to operate as one or more software modules in order to perform the operation of the present disclosure, and vice versa.

The programming module according to the present disclosure can include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for operating an electronic device, the method comprising:
distinguishing a first application that is running in the electronic device from a second application that is not running; and
adding a distinctive appearance on the a first app-icon representing the running application;
displaying the first app-icon distinctively from a second app-icon on a screen of the electronic device.

2. The method of claim 1, wherein the distinctive appearance comprises at least one of a color, a shade, a size and a design.

3. The method of claim 2, wherein all of first app-icons are displayed in the same distinctive feature and all of second app-icons are displayed in a different feature.

4. The method of claim 1, further comprising:
in response to detecting a change in an execution state of a running application, removing the distinctive appearance from the first app-icon.

5. The method of claim 1, further comprising:
receiving a selection of one of app-icons from a user; and
displaying a function list of the application corresponding to the selected app-icon.

6. The method of claim 5, wherein, when the selected app-icon is one of the first app-icon, the function list includes operation management items related to the app-icon, and
when the selected app-icon is one of the second app-icon, the function list includes at least one of operation management items related to the app-icon, operation management items related to the application, a bookmark related to the application, and preference items related to the application.

7. The method of claim 5, further comprising identifying properties of the application corresponding to the selected app-icon.

8. The method of claim 7, wherein the function list includes the properties of the application corresponding to the selected app-icon.

9. The method of claim 7, wherein the properties includes at least one of operation management items related to the app-icon, operation management items related to the application, a bookmark related to the application, and preference items related to the application.

10. The method of claim 5, further comprising:
receiving a selection of one of the function list from the user; and
executing the selected function of the application.

11. An electronic device comprising:
a control unit configured to:
distinguish a first application that is running in the electronic device from a second application that is not running; and
add a distinctive appearance on the a first app-icon representing the running application; and
a display configured to display the first app-icon distinctively from a second app-icon on a screen of the electronic device.

12. The electronic device of claim 11, wherein the first app-icon has a distinctive feature comprising at least one of a color, a shade, a size and a design.

13. The electronic device of claim 12, wherein all of first app-icons are displayed in the same distinctive feature and all of second app-icons are displayed in a different feature.

14. The electronic device of claim 11, wherein the control unit is further configured to in response to detecting a change in an execution state of a running application, remove the distinctive appearance from the first app-icon.

15. The electronic device of claim 11, wherein the control unit is further configured to:
receive a selection of one of app-icons from an input unit; and
cause the screen to display a function list of the application corresponding to the selected app-icon.

16. The electronic device of claim 15, wherein, when the selected app-icon is one of the first app-icon, the function list includes operation management items related to the app-icon, and when the selected app-icon is one of the second app-icon, the function list includes at least one of operation management items related to the app-icon, operation management items related to the application, a bookmark related to the application, and preference items related to the application.

17. The electronic device of claim 15, wherein the control unit is further configured to identify properties of the application corresponding to the selected app-icon.

18. The electronic device of claim 17, wherein the function list includes the properties of the application corresponding to the selected app-icon.

19. The electronic device of claim 15, wherein the properties includes at least one of operation management items related to the app-icon, operation management items related to the application, a bookmark related to the application, and preference items related to the application.

20. A computer-readable recording medium storing a program configured to perform, when executed by a processor, the operations of:
distinguishing a first application that is running in the electronic device from a second application that is not running; and
adding a distinctive appearance on the a first app-icon representing the running application;
displaying the first app-icon distinctively from the second app-icon on a screen of the electronic device.
